(19) United States
(12) Patent Application Publication
(10) Pub. No.: US 2019/0344748 A1
(43) Pub. Date: Nov. 14, 2019

(54) SHOULDER BELT ASSEMBLY WITH ADAPTIVE LOAD LIMITER

(71) Applicant: GM GLOBAL TECHNOLOGY OPERATIONS LLC, Detroit, MI (US)

(72) Inventors: Chin-hsu Lin, Troy, MI (US); Ashish Nayak, Bhopal (MP) (IN)

(73) Assignee: GM GLOBAL TECHNOLOGY OPERATIONS LLC, Detroit, MI (US)

(21) Appl. No.: 15/973,889

(22) Filed: May 8, 2018

(51) Int. Cl. B60R 22/48; B60R 22/42

(52) U.S. Cl. CPC B60R 22/48; B60R 2022/4808; B60R 22/42

(57) ABSTRACT

Methods and mechanisms for a shoulder belt assembly for a vehicle are provided. The shoulder belt assembly includes a shoulder belt mechanically coupled to a seat in the vehicle, a control module operationally coupled to the shoulder belt and a vehicle management system, the control module configured to detect current movement of the vehicle and passenger information for a passenger in a seat, identify an event, and generate a customized control signal that is a function of the current movement of the vehicle and a physical characteristic of the passenger in the seat. The shoulder belt assembly also has a load limiting mechanism configured to respond to the control signal by, causing a fold in the shoulder belt, the fold having the characteristics of (i) being oriented width-wise, and (ii) having a substantially uniform fold depth; and holding the fold in accordance with the control signal.

### TECHNICAL FIELD

The technical field generally relates to vehicles and, more specifically, to shoulder belt assemblies for vehicles.

### BACKGROUND

Many vehicles include shoulder belts and various seat belts to restrain and secure the passengers. Events that rapidly engage the shoulder belt have the potential to subject the passenger to stress where there is bodily contact with the shoulder belt. Non-limiting examples of events that rapidly engage the shoulder belt include rapid deceleration events, and situations in which a stopped or slowly moving vehicle receives contact. In addition to potential stress along the shoulder belt, physical characteristics of the passenger, such as weight and weight distribution over a seat, as well as seat position with respect to travel direction, can affect the potential stress and the passenger's experience of an event. To address these challenges, improved shoulder belt assemblies may be desired.

Accordingly, it is desirable to provide improved adaptive shoulder belt assemblies and/or associated shoulder belt assembly methods and mechanisms for vehicles. Furthermore, other desirable features and characteristics of the present invention will become apparent from the subsequent detailed description of the invention and the appended claims, taken in conjunction with the accompanying drawings and this background of the invention.

### SUMMARY

In accordance with an exemplary embodiment, a console drawer assembly is provided.

In one exemplary embodiment, a shoulder belt assembly for a vehicle is provided. The shoulder belt assembly includes a shoulder belt mechanically coupled to a seat in the vehicle, a control module operationally coupled to the shoulder belt, and a vehicle management system. The control module is configured to: identify an event; receive a physical characteristic of a passenger in the seat; and generate, responsive to the event, a control signal that is a function of the current movement of the vehicle and the physical characteristic of the passenger in the seat. The shoulder belt assembly also includes a load limiting mechanism mechanically coupled to the shoulder belt. The load limiting mechanism is configured to, cause a fold in the shoulder belt responsive to the control signal, the fold having the characteristics of (i) being oriented width-wise, and (ii) having a substantially uniform fold depth.

Also, in one embodiment, the load limiting mechanism includes: a braking component coupled to the shoulder belt, and an actuator. The braking component moveable between (a) an open position, in which it does not make contact with the shoulder belt, and (b) a deployed position, in which it makes contact with the shoulder belt sufficient to fold a portion of the shoulder belt over the braking component, resulting in a fold of the maximum fold depth. The actuator is configured to receive the control signal and change the position of the braking component responsive thereto, to cause the fold in the shoulder belt and achieve the fold depth in accordance with the control signal.

Also in one embodiment, the control module is additionally configured to detect a position and an orientation of the seat in the vehicle, and generate the control signal further as a function of the position and the orientation of the seat in the vehicle.

Also, in one embodiment, the load limiting mechanism is further configured to hold the fold in accordance with the control signal.

Also, in one embodiment, the physical characteristic of the passenger includes any combination of: height and weight.

Also in one embodiment, the control module is additionally configured to detect a size and a weight of the vehicle, and generate the control signal further as a function of the size and the weight of the vehicle.

Also in one embodiment, the control module is additionally configured to detect an object in a travel path of the vehicle, and generate the control signal further as a function of the detected object in the travel path of the vehicle.

Also, in an embodiment, the fold is a first fold, and the load limiting mechanism is further configured to, responsive to the control signal, cause a second fold in the shoulder belt, the fold having the characteristics of (i) being oriented width-wise over a second braking component, and (ii) having a substantially uniform second fold depth. The load limiting mechanism is further configured to hold the second fold in accordance with the control signal.

Also, in an embodiment, the braking component has at least one intermediate position between the open position and the deployed position. In the at least one intermediate position, the fold depth is more than zero and less than the maximum fold depth.

In another exemplary embodiment, a vehicle is provided. The vehicle includes a vehicle management system, a shoulder belt mechanically coupled to a seat in the vehicle, and a control module. The control module is operationally coupled to the shoulder belt and the vehicle management system. The control module is configured to, process vehicle data to identify an event; receive a physical characteristic of a passenger in the seat; and generate, responsive to the event, a control signal that is a function of the vehicle data and the physical characteristic of the passenger in the seat. The vehicle also includes a load limiting mechanism mechanically coupled to the shoulder belt. The load limiting mechanism includes a braking component and an actuator, the load limiting mechanism is configured to respond to the control signal by, changing a position of the braking component responsive to the control signal, such that the braking component causes a fold in the shoulder belt, the fold having the characteristics of (i) being oriented width-wise, and (ii) having a substantially uniform fold depth.

Also in one embodiment, the control module is additionally configured to detect a position and an orientation of the seat in the vehicle, and generate the control signal further as a function of the position and the orientation of the seat in the vehicle.

Also in one embodiment, the load limiting mechanism is further configured to hold the fold in accordance with the control signal.

Also in one embodiment, the physical characteristic of the passenger includes weight distribution within the seat.

Also in one embodiment, the control module is additionally configured to detect a size and a weight of the vehicle, and generate the control signal further as a function of the size and the weight of the vehicle.

Also in one embodiment, the control module is additionally configured to detect an object in a travel path of the vehicle, and generate the control signal further as a function of the detected object in the travel path of the vehicle.

Also in one embodiment, the fold is a first fold, the load limiting mechanism further includes a second braking component, and wherein the load limiting mechanism is further configured to respond to the control signal by, changing a position of the second braking component responsive to the control signal, such that the second braking component causes a second fold in the shoulder belt, the second fold having the characteristics of (i) being oriented width-wise, and (ii) having a substantially uniform second fold depth.

Also, in an embodiment, the braking component has at least one intermediate position between the open position and the deployed position. In the at least one intermediate position, the fold depth is more than zero and less than the maximum fold depth.

In another exemplary embodiment, a method for a shoulder belt assembly for a seat in a vehicle is provided. The method includes, at a control module, receiving, from a vehicle management system, vehicle data, environmental data, and a physical characteristic of a passenger in the seat and processing vehicle data to identify an event. The method includes generating, responsive to the event, a control signal that is a function of the vehicle data and the physical characteristic of the passenger in the seat. The method also includes, at a load limiting mechanism mechanically coupled to the shoulder belt, the load limiting mechanism having a braking component and an actuator, receiving the control signal; and changing a position of the braking component responsive to the control signal, such that the braking component causes a fold in the shoulder belt, the fold having the characteristics of (i) being oriented width-wise, and (ii) having a substantially uniform fold depth.

Also, in an embodiment, the physical characteristic of the passenger includes weight distribution within the seat, and further includes: detecting a position and an orientation of the seat in the vehicle; and generating the control signal further as a function of the position and the orientation of the seat in the vehicle and the weight distribution within the seat.

Also, in an embodiment, the method includes detecting an object in a travel path of the vehicle, and generating the control signal further as a function of the detected object in the travel path of the vehicle.

### DESCRIPTION OF THE DRAWINGS

The present disclosure will hereinafter be described in conjunction with the following drawing figures, wherein like numerals denote like elements, and wherein:

FIGS. 1-2 are functional block diagrams of a vehicle that includes an adaptive shoulder belt assembly, in accordance with an exemplary embodiment;

FIG. 3 is a functional block diagram of an adaptive shoulder belt assembly, in accordance with an exemplary embodiment;

FIGS. 4-7 are simplified illustrations of a load limiting mechanism, in accordance with an exemplary embodiment;

FIGS. 8-11 are simplified illustrations of a load limiting mechanism, in accordance with another exemplary embodiment;

FIGS. 12-16 are simplified illustrations of various levels of deployment of a load limiting mechanism, in accordance with various embodiments;

FIG. 17 is a graph showing how the load limiting mechanism limits the force on a shoulder belt to varying degrees associated with levels of deployment shown in FIGS. 12-15, in accordance with various embodiments;

FIGS. 18-20 are simplified illustrations of a load limiting mechanism, in accordance with still another exemplary embodiment;

FIG. 21 is a simplified illustration showing different surface friction on a braking component of a load limiting mechanism, in accordance with various exemplary embodiments; and

FIG. 22 is a flow chart for a method for determining a control signal to operate the load limiting mechanism, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

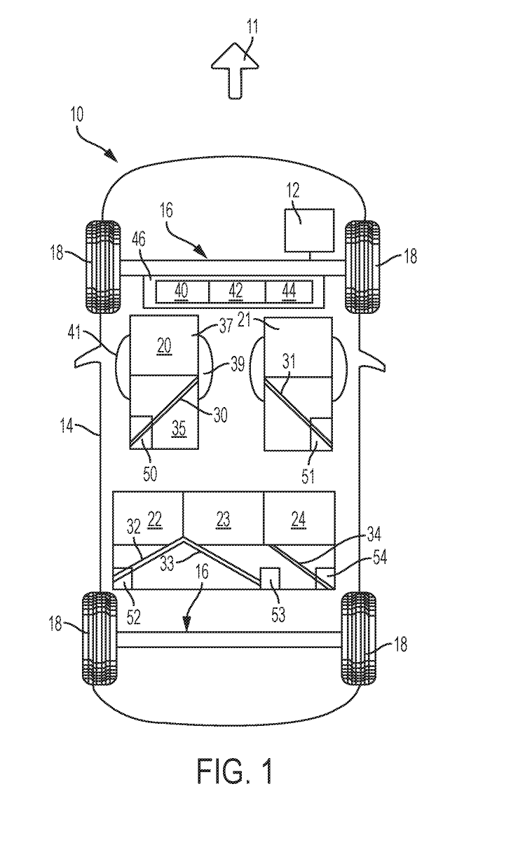

FIG. 1 illustrates a vehicle 10, according to an exemplary embodiment. As described in greater detail further below, the vehicle 10 includes one or more shoulder belt assemblies (50-54) configured to restrain a respective one or more occupants (e.g., drivers and/or passengers) of the vehicle 10. The vehicle 10 preferably comprises a land-based automobile. The vehicle 10 may be any one of many different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 10 may also comprise a motorcycle or other vehicle, or other system. Although the example provided herein is a shoulder belt, the concepts presented may be applied to seat belts and other similar restraining devices.

The vehicle 10 includes a body 14 that is arranged on a chassis 16. The body 14 substantially encloses other components of the vehicle 10. The body 14 and the chassis 16 may jointly form a frame. The vehicle 10 also includes a plurality of wheels 18. The wheels 18 are each rotationally coupled to the chassis 16 near a respective corner of the body 14 to facilitate movement of the vehicle 10. The vehicle 10 is generally operational for travel in the forward direction 11, although it may also travel in reverse. In one embodiment, the vehicle 10 includes four wheels 18, although this may vary in other embodiments (for example for trucks and certain other vehicles).

The vehicle 10 includes an onboard vehicle management system 46 that is a centralized processing system. The vehicle management system 46 receives and processes multiple signals. Non limiting examples of signals received and processed include: vehicle operational data (40), such as velocity, acceleration, turning ratio, object detection inputs, seat position, seat orientation, and cloud or other wireless communications; environmental data (42), such as precipitation, temperature, and wind speed; passenger data (44) including sensed physical characteristics such as weight, height, sensed weight distribution within and among seats, as well as passenger entered characteristics, such as age and gender; information about objects detected in the vehicle's path, and objects detected to be moving toward the vehicle (from any angle) from an object detection system; drive train information; brake system information; and tire pressure status information.

A drive system 12 is mounted on the chassis 16, and drives the wheels 18. The drive system 12 preferably comprises a propulsion system. In certain exemplary embodiments, the drive system 12 comprises an internal combustion engine and/or an electric motor/generator, coupled with a transmission thereof. In certain embodiments, the drive system 12 may vary, and/or two or more drive systems 12 may be used. By way of example, the vehicle 10 may also incorporate any one of, or combination of, many different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

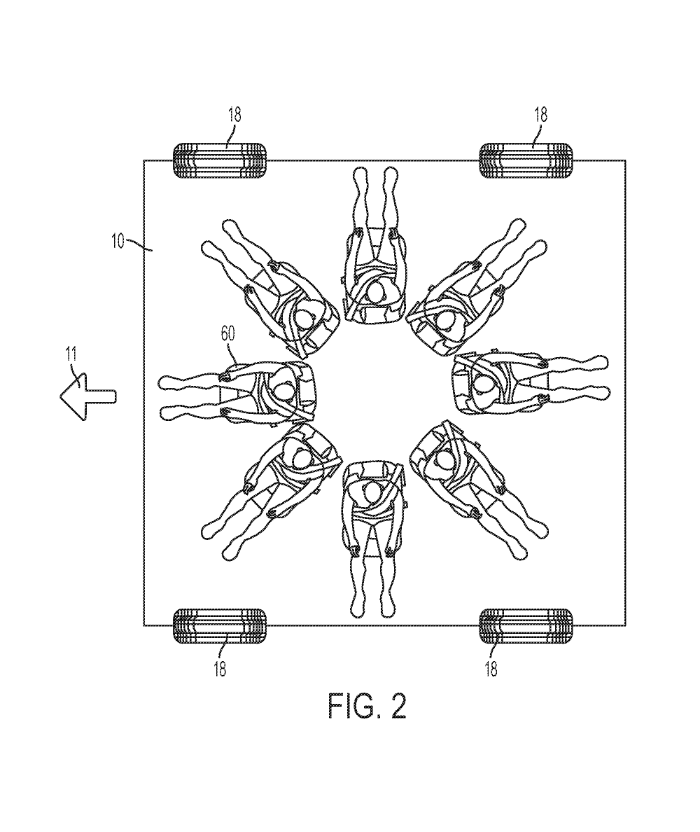

With reference to FIG. 1 and FIG. 2, the vehicle 10 includes occupant seating, which may be configured in various ways, with respect to the “forward” travel direction 11. In the embodiment depicted in FIG. 1, occupant seating is configured such that passengers are oriented to face the forward travel direction 11 (also referred to as “facing forward”), as indicated by front seats 20 and 21 (e.g., a front driver seat and a front passenger seat, in one embodiment) and one or more rear seats 22, 23, and 24. Note that seat 60 (FIG. 2) is configured to orient a passenger face forward. However, FIG. 2 also depicts various other configurations of the seats, with respect to the forward travel direction 11, resulting in orienting passengers in angular offsets ranging from zero to 360, as measured from the travel direction 11.

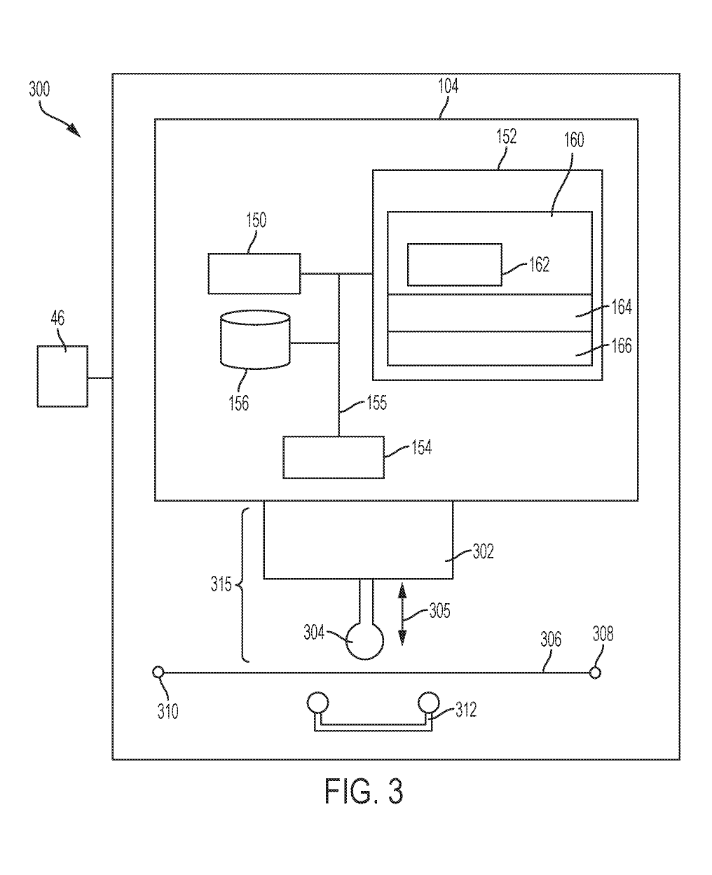

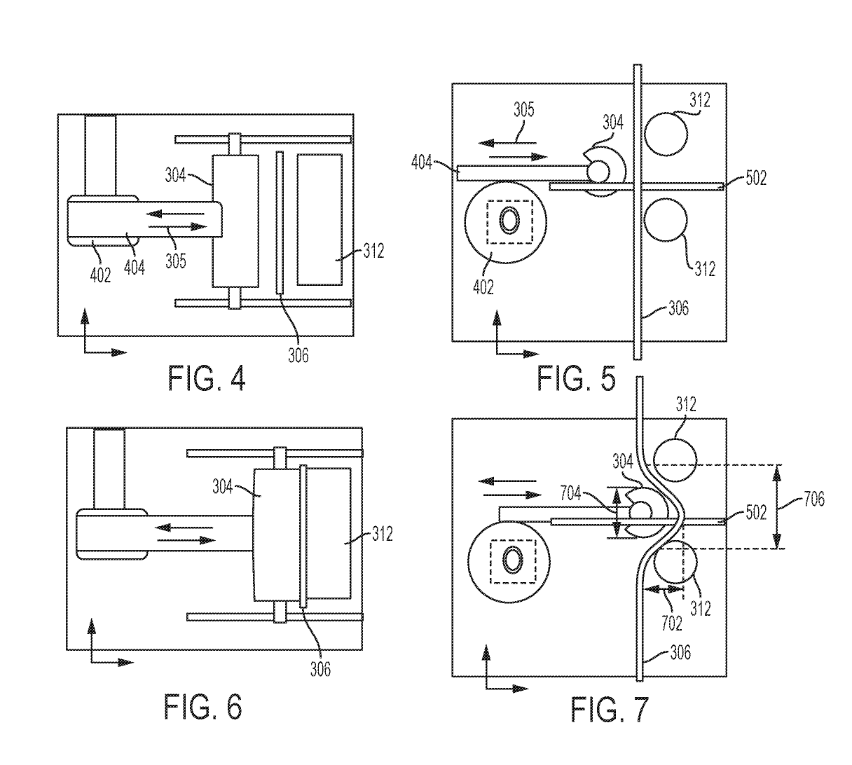

Each seat comprises a seat back 35, and a seat bottom 37, and may comprise one or more arm rests 39, 41. Sensors of a variety of different forms (pressure, optical, etc.) may be placed around the seat back 35, and a seat bottom 37, and the one or more arm rests 39, 41 to detect physical characteristics such as weight, height, and weight distribution in the seat. A shoulder belt is associated with each seat, extending from above an occupant's shoulder on one side of the occupant's body to the outside of the occupant's waist on the other side of the occupant's body. In the embodiment of FIG. 1, shoulder belt 30 is mechanically coupled to seat 20, shoulder belt 31 is mechanically coupled to seat 21, shoulder belt 32 is mechanically coupled to seat 22, shoulder belt 33 is mechanically coupled to seat 23, and shoulder belt 34 is mechanically coupled to seat 24. Regardless of the seat orientation, whether the shoulder belt crosses from left shoulder to right hip or from right shoulder to left hip is a design specific determination, the herein described shoulder belt assembly (50-54) works the same way in each case. Each shoulder belt (30-34) is a component of a respective adaptive shoulder belt assembly (50-54). The components of the adaptive shoulder belt assemblies (50-54) (referred to as shoulder belt assemblies for simplicity) and their operation are described, generally, in connection with FIG. 3, and with more specific details in connection with FIGS. 4-21 below.

An embodiment of a shoulder belt assembly 300 is depicted in FIG. 3. The shoulder belt assembly 300 is configured to receive inputs from the vehicle management system 46 onboard the vehicle 10. In some embodiments, the shoulder belt assembly 300 may be placed between a D-ring commonly used in shoulder belts, and a retracting mechanism, not shown. The shoulder belt assembly 300 includes a control module 104 operationally coupled to the shoulder belt 306 and a load limiting mechanism 315. Load limiting mechanism 315 is mechanically coupled to the shoulder belt 306. In FIG. 3, the load limiting mechanism 315, shoulder belt 306, and an optional stabilizing structure 312, are depicted in a two-dimensional top view. Shoulder belt 306 may be of industry standard materials and dimensions, having a generally rectangular shape, with a length, a width, and nominal thickness. The length is the dimension that extends across the passenger from shoulder to hip, when connected. When a shoulder belt 306 is connected (i.e., engaged, attached, secured in position, etc.), over the passenger, and operating conditions are normal, shoulder belt 306 provides a low level of force, perceived as tension or initial tautness. In FIG. 3, the shoulder belt 306 is stretched taut, representing a seat-belt being connected (i.e., engaged, secured in position, etc.), over the passenger. In an embodiment, point A (308) may be D-ring or other fastener above a passenger's shoulder, and point B (310) may be an anchor point, often at the lower B-pillar. When shoulder belt 306 is taut, it has a first shoulder belt length. For the present discussion, the shoulder belt is taut, and the shoulder belt length shall be from point A (308) to point B (310).

As used herein, non-limiting examples of “events” that rapidly engage the shoulder belt include rapid deceleration events, and situations in which a stopped or slowly moving vehicle receives contact or is anticipated to receive contact. The control module 104 processes inputs from the vehicle management system 46 and determines when an event is occurring. In response to determining that an event is occurring, the control module 104 processes additional inputs and generates therefrom a command for the load limiting mechanism 350 that is sent as a customized load limiting control signal (shortened herein to “control signal” for convenience). The control signal may include commands to deploy, how much to deploy, and for how long to deploy. The control signal is described in more detail below.

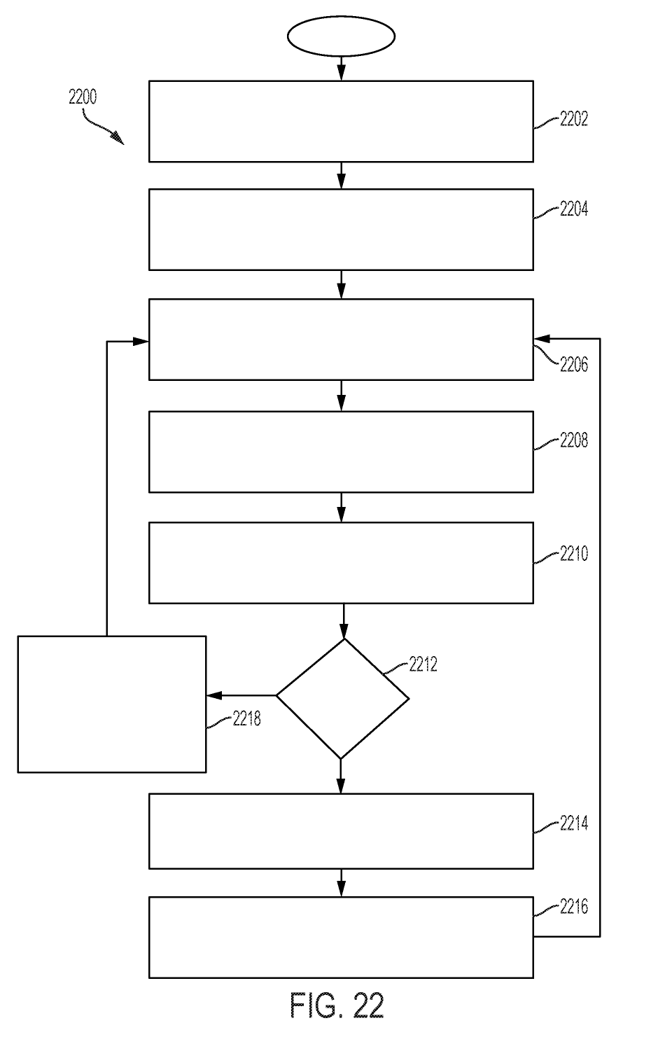

In some embodiments, determining that an event is occurring is performed by the control module 104, via processing steps of a method encoded in program 162, such as method 2200 described in connection with FIG. 22. In other embodiments, an event is identified by other processing components, outside of the control module 104, and transmitted to the control module 104. Regardless of the origin of the event identification, the control signal itself may be a function of a combination of vehicle operational data (40), environmental data (42), and passenger data (44). In an embodiment, the control signal is customized to a passenger, the vehicle, and the environment; in an embodiment, the control signal is customized to a passenger, and the environment; in an embodiment, the control signal is customized to a passenger, and the vehicle.

The load limiting mechanism 315 operates mechanically on the shoulder belt 306, the mechanical operation being responsive to the control signal generated by the control module 104. In an embodiment, the load limiting mechanism 315 comprises an actuator 302 and a braking component 304. The control signal commands movement of the braking component 304 and positions to which the braking component 304 shall be moved. The actuator 302 is configured to convert the control signal into mechanical action, and apply the mechanical action to move the braking component 304 and change its position accordingly. In the embodiment shown in FIG. 3, arrow 305 shows movement of the braking component 304, toward and away from the shoulder belt 306. As will be described in more detail below, the movement of the braking component 304 is sufficient to cause a fold in the shoulder belt that is substantially uniform in fold depth, and “width-wise,’ or perpendicular to the length of the shoulder belt, as shown point A (308) to point B (310).

The load limiting mechanism 315, via the actuator 302, responds to the control signal by moving the braking component 304 into and out of a deployed position. As shown in FIGS. 4-15, moving the braking component 304 as described causes a controlled fold near the braking component 304. The fold has a fold uniform fold depth (70, 72, 74) that is embedded in the command in the control signal and is a function of the dimensions of the braking component 304. In the deployed position, the braking component 304 impinges into the shoulder belt 306, causing the shoulder belt 306 to fold near the braking component 304 (the fold is also over the braking component 304); the fold has a substantially uniform fold depth. A technical effect of the load limiting mechanism 315, when engaged, is that it effectively shortens the shoulder belt 306 in an area of contact with the passengers' chest, from its first shoulder belt length to a shortened length that is customized and adapted to an individual passenger. This shortening may result in more shoulder belt material being between the D-ring and the anchor point. The shortened length is experienced by a passenger as a tightening or pulling of shoulder belt 306 over its initial tautness. The passenger may then experience this tightening as an increased sense of protection during an event.

In addition to moving the braking component 304, the load limiting mechanism 315 may be configured to hold the fold, by holding the braking component 304 in the respective deployed position for a duration of time. The duration of time is a variable that is determined by the control module 104 and indicated by the customized load limiting signal. In various embodiments, the load limiting mechanism 315 may further have a stabilizing structure 312, that stabilizes the shoulder belt 306 during deployment of the braking component.

As mentioned, the control module 104 processes the inputs and directs mechanical operation of the load limiting mechanism 315 of the shoulder belt assembly 300. As used herein, the term “module” refers to any hardware, software, firmware, electronic control component, processing logic, and/or processor device, individually or in any combination, configured as a means for facilitating communications and/or interaction between the elements of the shoulder belt assembly 300 and performing additional processes, tasks and/or functions to support operation of the shoulder belt assembly 300, as described herein. Depending on the embodiment, the control module (FIG. 3, 104) may be implemented or realized with a general purpose processor (shared, dedicated, or group) controller, microprocessor, or microcontroller, and memory that executes one or more software or firmware programs; a content addressable memory; a digital signal processor; an application specific integrated circuit (ASIC), a field programmable gate array (FPGA); any suitable programmable logic device; combinational logic circuit including discrete gates or transistor logic; discrete hardware components and memory devices; and/or any combination thereof, designed to perform the functions described herein. In some embodiments, the control module 104 may be integrated into the vehicle management system 46.

In an embodiment of the control module 104, depicted in FIG. 3, a processor 150 and a memory 152 form a novel processing engine or unit that performs the processing activities for operation of the shoulder belt assembly 300. The processor 150 may comprise any type of processor or multiple processors, single integrated circuits such as a microprocessor, or any suitable number of integrated circuit devices and/or circuit boards working in cooperation to carry out the described operations, tasks, and functions by manipulating electrical signals representing data bits at memory locations in the system memory, as well as other processing of signals. The memory 152 is a data storage element that maintains data bits and may be utilized by the processor 150 as storage and/or a scratch pad. The memory 152 may be located on and/or co-located on the same computer chip as the processor 150. In the depicted embodiment, the memory 152 stores instructions and applications 160 and one or more configurable variables in stored variables 164. In various embodiments, the database 156 may be used for storage of biometrics rules, passenger specific information (passenger height, weight, age, preferences, etc.), and/or vehicle specific information (such as weight class, seat configuration, etc.). Buffer 166 represents data storage. Information in the memory 152 may be organized and/or imported from an external data source during an initialization step of a process.

A novel program 162 is embodied in the memory 152 (e.g., RAM memory, ROM memory, flash memory, registers, a hard disk, or the like) or another suitable non-transitory short or long-term storage media capable of storing computer-executable programming instructions or other data for execution. The program 162 includes rules and instructions which, when executed, cause the shoulder belt assembly 300 to perform the processing functions associated with the operation of the shoulder belt assembly 300 described herein.

During operation, the processor 150 loads and executes one or more programs, algorithms and rules embodied as instructions and applications 160 contained within the memory 152 and, as such, controls the general operation of the control module 104 as well as the shoulder belt assembly 300. In executing the process described herein, the processor 150 specifically loads and executes the instructions embodied in the program 162. Additionally, the processor 150 is configured to, in accordance with the program 162: selectively process received inputs (such as, but not limited to, any combination of vehicle operation data, environmental data, seat position, seat orientation, and physical characteristics or biometrics associated with the passenger); reference the database 156; identify an event; generate adaptive customized load limiting signals (control signals); and, transmit the control signals to the load limiting mechanism 315.

In various embodiments, the processor/memory unit of the control module 104 may be communicatively coupled (via a bus 155) to an input/output (I/O) interface 154, and a database 156. The bus 155 serves to transmit programs, data, status and other information or signals between the various components of the control module 104. The bus 155 can be any suitable physical or logical means of connecting computer systems and components. This includes, but is not limited to, direct hard-wired connections, fiber optics, infrared and wireless bus technologies.

The I/O interface 154 enables communications between the control module 104 and other shoulder belt assembly 300 components, as well as with other external data sources 112 not already addressed herein, and as well as within the control module 104. The I/O interface 154 can include one or more network interfaces to communicate with other systems or components. The I/O interface 154 can be implemented using any suitable method and apparatus. For example, the I/O interface 154 supports communication from a system driver and/or another computer system. In one embodiment, the I/O interface 154 obtains data from external data source(s) 140 directly. The I/O interface 154 may also include one or more network interfaces to communicate with technicians, and/or one or more storage interfaces for direct connection to storage apparatuses, such as the database 156.

FIGS. 4-7 depict an embodiment of the shoulder belt assembly. The actuator 302 comprises a motor 402 and a motor arm 404 which cooperate to move braking component 304 toward and away from the shoulder belt 306, as indicated by arrows 305. As previously stated, the shoulder belt assembly may be located before the D-ring, not between the D-ring and the buckle.

FIG. 4 and FIG. 6 are top views; in FIG. 4 the braking component 304 is not deployed, and in FIG. 6 the braking component is deployed. FIG. 5 and FIG. 7 are side views; in FIG. 5, the braking component 304 is not deployed, and in FIG. 7, the braking component 304 is deployed. The fold is caused by moving the braking component 304 from the actuator 302 toward the shoulder belt 306, essentially pushing it into the shoulder belt 306. An optional stabilizing structure 312 straddles the braking component 304 on an opposite side of the shoulder belt 306 than the braking component 304 and may assist in folding the shoulder belt 306 over the braking component 304 as the braking component 304 is pushed into the shoulder belt 306. An optional guide bar 502 may additionally provide stability for the braking component 304 as it moves toward and away from the shoulder belt 306. The controlled fold of the shoulder belt 306, over the braking component 304, comprises a fold depth 702 that is a function of the dimensions of the braking component 304. In FIG. 7, because the braking component 304 has a thickness 704, the controlled fold may have a fold width 706 that is based on the thickness 704.

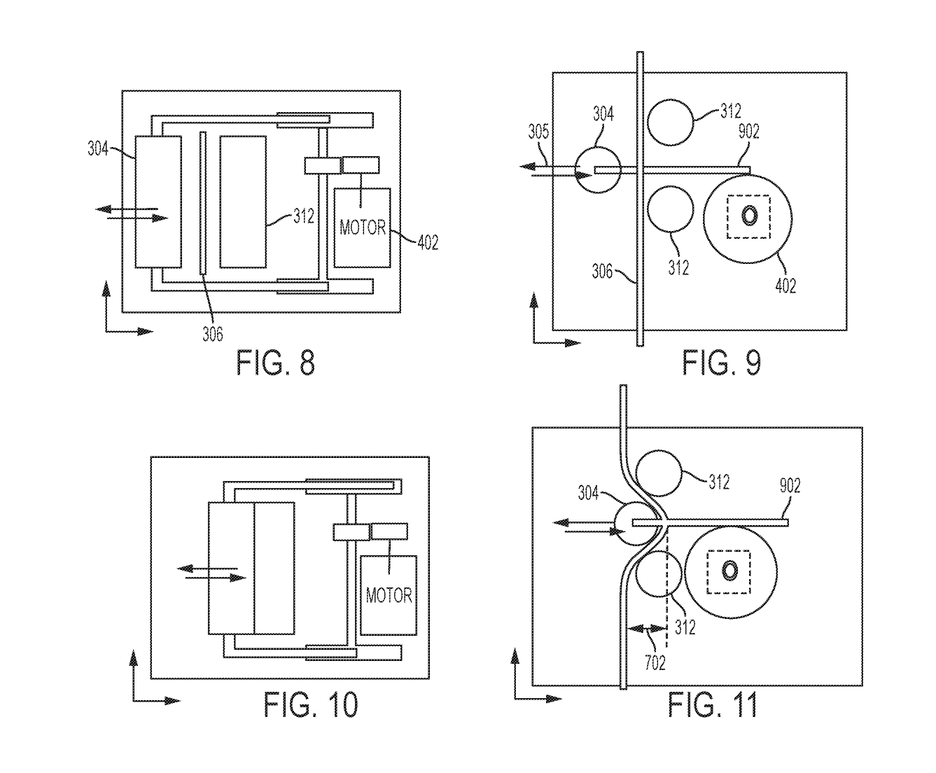

The embodiment of FIGS. 4-7 depicts the braking component 304, motor 402, and motor arm 404 all on a same side, a first side of the shoulder belt 306. This embodiment may be referred to as a “push style.” In another embodiment, shown in FIGS. 8-11, the braking component 304 is on the opposite side of the shoulder belt 306 from the motor 402 and motor arm 404, and may be referred to as a “pull style.” FIG. 8 and FIG. 10 are top views; in FIG. 8 the braking component 304 is not deployed, and in FIG. 10 the braking component is deployed. FIG. 9 and FIG. 11 are side views; in FIG. 9, the braking component 304 is not deployed, and in FIG. 11, the braking component 304 is deployed. In this embodiment, rather than essentially pushing the braking component 304 into the shoulder belt 306, the controlled fold is caused by moving the braking component 304 the opposite direction, essentially pulling it into the shoulder belt 306. An optional guide rail 902 may be used to provide stability to the braking component 304.

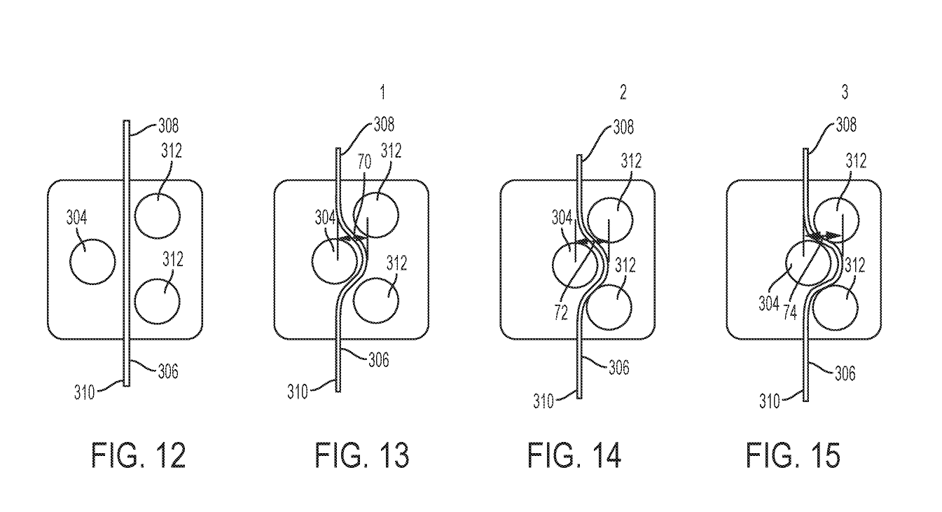

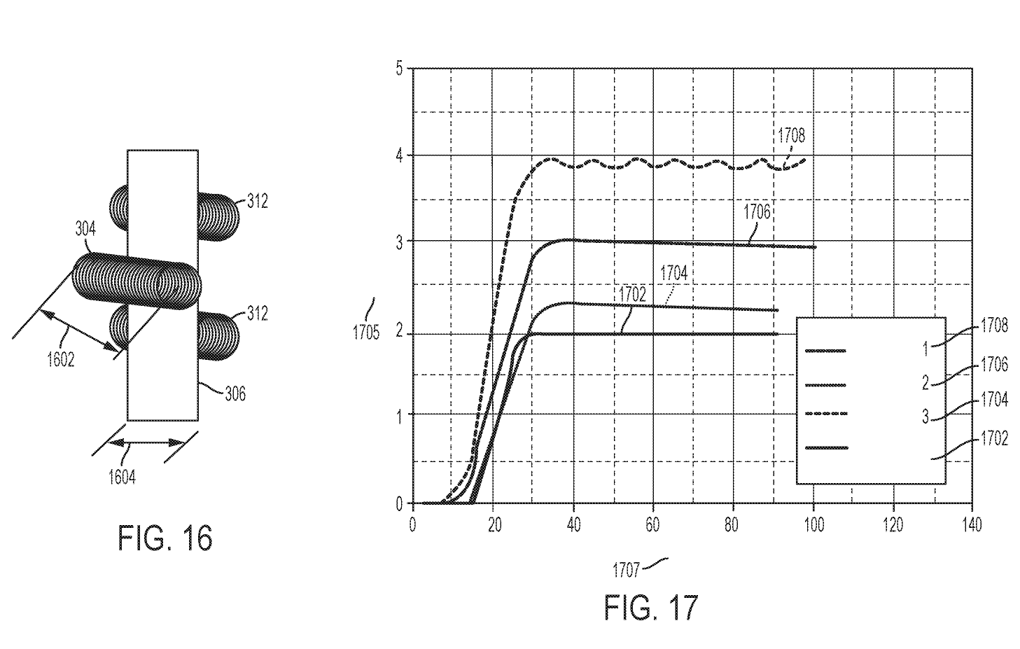

When a maximum fold depth is commanded in the control signal, the braking component 304 is maximally deployed. However, in various embodiments, the fold depth is a variable parameter, determined by the control module 104, and indicated in the customized control signal. With reference to FIGS. 12-17, this concept is further described. FIG. 12 depicts zero percent deployed, FIG. 13 depicts a first position of intermediate deployment, FIG. 14 depicts a second position of intermediate deployment that is greater deployment than FIG. 13, and FIG. 15 depicts one hundred percent deployment. As shown in FIG. 16, the braking component 304 has a width 1602 that is at least as wide as the shoulder belt 306 (having width 1604), sufficient to ensure the uniformity of the fold depth. In operation, friction between the surface of the braking component 304 and the shoulder belt 306, optionally increased by restraint provided by the stabilizing structure 312, results in a restraining force (in kilo Newtons kN) of the load limiting mechanism 315. As may be seen, the fold depth is zero in FIG. 12. The fold depth 70 in FIG. 13 is more than zero, but less than the fold depth 72 of FIG. 14. The fold depth 72 in FIG. 14 is more than fold depth 70, but less than the fold depth 74 of FIG. 15. The fold depth has a corresponding limiting force, in kN (the Y axis), over time (the X axis), as depicted in the graph of FIG. 17. In the example embodiment of FIG. 17, a neutral position in which the shoulder belt 306 is attached, but the braking component 304 is not deployed (FIG. 12 the previously described “initial tautness”) is associated with a 2 kN force (1702). The first position has slightly more force (1704), the second position has more than the first position (1706) (approximately 3 kN), and the fully deployed position (1708) provides approximately 4 kN of force. A technical effect of the variable deployment positions is an enhanced adaptability, for example, on a passenger by passenger, seat by seat, and weight distribution by weight distribution manner.

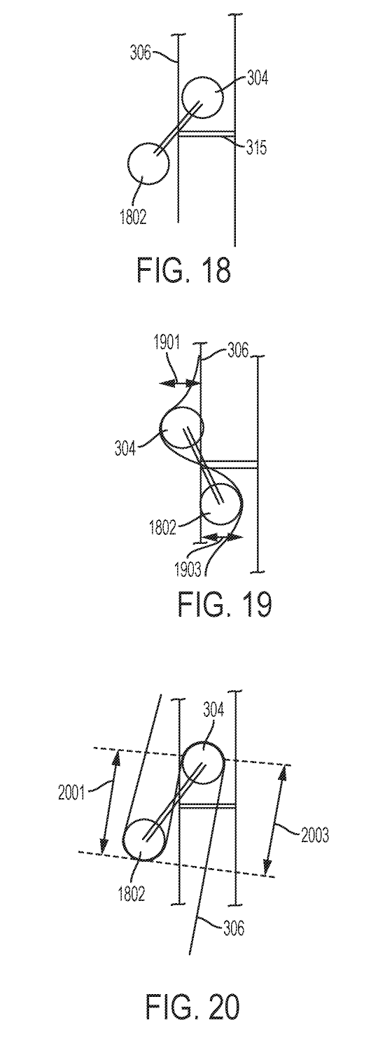

In some embodiments, the braking component 304 is one of two braking components that cooperatively create the fold. This concept is illustrated in FIGS. 18-20, in which braking component 304 is joined by braking component 1802. As is illustrated, the braking component 304 is on a first side of the shoulder belt 306, and the braking component 1802 is on a second side of the shoulder belt 306 (i.e. the opposite side”). In response to the control signal from the control module 104, causing the fold includes concurrently pushing the braking component 304 into the first side of the shoulder belt 306, and pulling the braking component 1802 into the second side of the shoulder belt 306. In a partial deployment shown in FIG. 19, the fold is described by the combination of fold depth 1901 and fold depth 1903. In FIG. 20, a full deployment (100 percent deployment) is shown, in which the fold is described by fold depth 2001 and fold depth 2003.

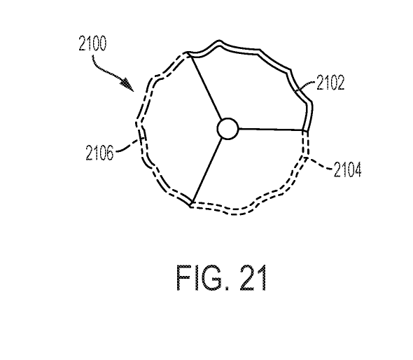

As may be appreciated, the braking component 304 has a surface friction. In some embodiments, the braking component 304 may have regions of differing surface friction. In FIG. 21, the braking component 2100 is shown having a first surface friction 2102, a second surface friction 2104, and a third surface friction 2106. Selectively, the surface frictions (2102-2104) can be associated with any combination of biometric profiles, such as gender, height, and weight; body weight distribution; and passenger preference. For example, a female in the fifth percentile may be associated with the first surface friction 2102; a male in the 50th percentile may be associated with the second surface friction 2104; and, a male in the 95th percentile may be associated with the third surface friction 2106. The actuator 302 may further be configured to, responsive to the control signal, move the braking component 304 into the desired position prior to pushing it or pulling it into the shoulder belt 306. Further still, any of the individually described braking components 304, 1802, and 2100 may be combined in an embodiment of the load limiting mechanism 315. For example, an embodiment may have a push style braking component 304 (FIGS. 4-7) that has multiple surface frictions; another embodiment may have a pull style braking component 304 (FIGS. 8-11) that has multiple surface frictions; another embodiment may have two braking components 304, 1802 (FIGS. 18-20) that each have multiple surface frictions; and, another embodiment may have two braking components 304, 1802 (FIGS. 18-20) one having multiple surface frictions, the other having only one surface friction.

Referring now to FIG. 22 and with continued reference to FIGS. 1-21, a flow chart is provided for a method 2200 for providing a control signal, in accordance with various exemplary embodiments. Method 2200 represents various embodiments of a method associated for generating the herein referenced control signal. For illustrative purposes, the following description of method 2200 may refer to elements mentioned above in connection with FIG. 3. In practice, portions of method 2200 may be performed by different components of the described system. It should be appreciated that method 2200 may include any number of additional or alternative tasks, the tasks shown in FIG. 22 need not be performed in the illustrated order, and method 2200 may be incorporated into a more comprehensive procedure or method having additional functionality not described in detail herein. Moreover, one or more of the tasks shown in FIG. 22 could be omitted from an embodiment of the method 2200 if the intended overall functionality remains intact.

The method starts, and at 2202 the control module 104 is initialized. As mentioned above, initialization may comprise uploading or updating instructions and applications 160, program 162, stored variables 164, and various lookup tables stored in the database 156. Predetermined variables may include, for example, predetermined distances and times to use as thresholds for identifying an event, and parameters for gender or age specific modifications, and the like.

Vehicle operation data is continuously monitored. As mentioned, vehicle operation data includes current movement of the vehicle (including any combination of: velocity, acceleration, and turning ratio), a size of the vehicle, a weight of the vehicle, and a position and an orientation of the seat in the vehicle. At 2204, current vehicle movement is detected.

At 2206, environmental conditions are monitored. Specifically, the control module 104 processes available current environmental data such as precipitation, road conditions (wet, uneven, etc.), wind, and the like, against thresholds. The passenger data (44) is continuously monitored. If there are multiple passengers, the passenger data (44) for each of the passengers is continuously monitored. As mentioned, passenger data (44) includes sensed physical characteristics such as weight, height, sensed weight distribution within and among seats, as well as passenger entered characteristics, such as age and gender. Passenger data (44) can vary the thresholds for determining that an event is occurring, in addition to having an influence on how the respective shoulder belt assembly responds to the event (via the control signal generated). At 2208, physical characteristics and other passenger data (44) are received. At 2210, additional optional data may be received and monitored. This may include other signals available from the vehicle management system 46, such as detection of an object in a travel path of the vehicle, by an object detection system, commands and information received wirelessly, drive train information, brake system information, and the like.

The continuously received vehicle data (40) and environmental data (42) are processed using thresholds and rules in program 162 to identify when an event is occurring at 2212. As used herein, “identifying an event” means identifying that an event is “occurring,” i.e., in real-time, right now, etc. Further, identifying an event encompasses early detection or anticipation of the event, and therefore includes any amount of time prior to the event that results from the early detection or anticipation of the event, in addition to the real-time, or currently happening, event. Examples of this include, but are not limited to, situations such as, receiving environmental data that an object is traversing in the vehicle's travel path, receiving environmental data that a neighbor vehicle is approaching the back or the side of the vehicle 10, whether or not the vehicle 10 is in motion, and receiving environmental or wireless communication information that a road surface ahead (i.e., in the travel path of the vehicle 10) is uneven or slippery.

Responsive to identifying that an event is occurring, a control signal that is an adaptive, customized response is generated (2214), as a function of at least two of: vehicle data (40), environmental data (42), and passenger data (44). For example, in an embodiment, the control signal is a function of the current movement of the vehicle and a weight of the passenger in the seat. At 2216, the load limiting mechanism 315 is deployed responsive to the control signal. As mentioned, the deployment may include a duration of time for holding the deployed position. When there are a number, N, of passengers in the vehicle 10, N unique adaptive customized responses are generated, one associated with each passenger based on the passenger's personal passenger data (44). After operating the load limiting mechanism 315, the method 2200 may end or may return to 2206.

As mentioned, the received vehicle data (40) and environmental data (42) are continuously monitored to identify when an event is occurring at 2212. When the method passes to this step (2212) and an event is not identified, the method 2200 either ceases a prior deployment of the load limiting mechanism 315, or does no action if the load limiting mechanism 315 is not deployed (2218). If an event is not occurring at 2212, that may mean that it did not occur, or that it occurred, but has ended.

Accordingly, the systems, vehicles, and mechanisms using the shoulder belt assembly 300 described herein provide improved response to events that may rapidly engage a shoulder belt. The shoulder belt assembly 300 mechanisms and systems provide for a potentially improved rapid shoulder belt engagement that is customized to one or more individual passengers in the vehicle, providing improved performance, and comfort.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. Various changes can be made in the function and arrangement of elements without departing from the scope of the disclosure as set forth in the appended claims and the legal equivalents thereof cm What is claimed is:

1. A shoulder belt assembly for a vehicle, comprising:
a shoulder belt mechanically coupled to a seat in the vehicle;
a control module operationally coupled to the shoulder belt and a vehicle management system, the control module configured to,
identify an event;
receive a physical characteristic of a passenger in the seat; and
generate, responsive to the event, a control signal that is a function of the current movement of the vehicle and the physical characteristic of the passenger in the seat; and
a load limiting mechanism mechanically coupled to the shoulder belt, the load limiting mechanism configured to,
cause a fold in the shoulder belt responsive to the control signal, the fold having the characteristics of (i) being oriented width-wise, and (ii) having a substantially uniform fold depth.

2. The shoulder belt assembly of claim 1, wherein the load limiting mechanism comprises:
a braking component coupled to the shoulder belt, the braking component moveable between (a) an open position, in which it does not make contact with the shoulder belt, and (b) a deployed position, in which it makes contact with the shoulder belt sufficient to fold a portion of the shoulder belt over the braking component, resulting in a fold of the maximum fold depth; and
an actuator configured to receive the control signal and change the position of the braking component responsive thereto, to cause the fold in the shoulder belt and achieve the fold depth in accordance with the control signal.

3. The shoulder belt assembly of claim 2, wherein the control module is additionally configured to:
detect a position and an orientation of the seat in the vehicle; and
generate the control signal further as a function of the position and the orientation of the seat in the vehicle.

4. The shoulder belt assembly of claim 3, wherein the load limiting mechanism is further configured to hold the fold in accordance with the control signal.

5. The shoulder belt assembly of claim 3, wherein the physical characteristic of the passenger includes any combination of: height and weight.

6. The shoulder belt assembly of claim 5, wherein the control module is additionally configured to:
detect a size and a weight of the vehicle; and
generate the control signal further as a function of the size and the weight of the vehicle.

7. The shoulder belt assembly of claim 6, wherein the control module is additionally configured to:
detect an object in a travel path of the vehicle; and
generate the control signal further as a function of the detected object in the travel path of the vehicle.

8. The shoulder belt assembly of claim 7, wherein the fold is a first fold, and wherein the load limiting mechanism is further configured to, responsive to the control signal,
cause a second fold in the shoulder belt, the fold having the characteristics of (i) being oriented width-wise over a second braking component, and (ii) having a substantially uniform second fold depth; and
hold the second fold in accordance with the control signal

9. The shoulder belt assembly of claim 7, wherein the braking component has at least one intermediate position between the open position and the deployed position, in which the fold depth is more than zero and less than the maximum fold depth.

10. A vehicle, comprising:
and a vehicle management system;
a shoulder belt mechanically coupled to a seat in the vehicle;
a control module operationally coupled to the shoulder belt and the vehicle management system, the control module configured to,
process vehicle data to identify an event;
receive a physical characteristic of a passenger in the seat; and
generate, responsive to the event, a control signal that is a function of the vehicle data and the physical characteristic of the passenger in the seat; and
a load limiting mechanism mechanically coupled to the shoulder belt, the load limiting mechanism comprising a braking component and an actuator, the load limiting mechanism configured to respond to the control signal by,
changing a position of the braking component responsive to the control signal, such that the braking component causes a fold in the shoulder belt, the fold having the characteristics of (i) being oriented width-wise, and (ii) having a substantially uniform fold depth.

11. The vehicle of claim 10, wherein the control module is additionally configured to:
detect a position and an orientation of the seat in the vehicle; and
generate the control signal further as a function of the position and the orientation of the seat in the vehicle.

12. The vehicle of claim 11, wherein the load limiting mechanism is further configured to hold the fold in accordance with the control signal.

13. The vehicle of claim 12, wherein the physical characteristic of the passenger includes weight distribution within the seat.

14. The vehicle of claim 13, wherein the control module is additionally configured to:
detect a size and a weight of the vehicle; and
generate the control signal further as a function of the size and the weight of the vehicle.

15. The vehicle of claim 14, wherein the control module is additionally configured to:
detect an object in a travel path of the vehicle; and
generate the control signal further as a function of the detected object in the travel path of the vehicle.

16. The vehicle of claim 15, wherein the fold is a first fold, the load limiting mechanism further comprises a second braking component, and wherein the load limiting mechanism is further configured to respond to the control signal by,
changing a position of the second braking component responsive to the control signal, such that the second braking component causes a second fold in the shoulder belt, the second fold having the characteristics of (i) being oriented width-wise, and (ii) having a substantially uniform second fold depth.

17. The vehicle of claim 15, wherein the braking component has at least one intermediate position between the open position and the deployed position, in which the fold depth is more than zero and less than the maximum fold depth.

18. A method for a shoulder belt assembly for a seat in a vehicle, the method comprising:
at a control module,
receiving, from a vehicle management system, vehicle data, environmental data, and a physical characteristic of a passenger in the seat;
processing vehicle data to identify an event;
and
generating, responsive to the event, a control signal that is a function of the vehicle data and the physical characteristic of the passenger in the seat;
and
at a load limiting mechanism mechanically coupled to the shoulder belt, the load limiting mechanism comprising a braking component and an actuator,
receiving the control signal; and
changing a position of the braking component responsive to the control signal, such that the braking component causes a fold in the shoulder belt, the fold having the characteristics of (i) being oriented width-wise, and (ii) having a substantially uniform fold depth.

19. The method of claim 18, wherein the physical characteristic of the passenger includes weight distribution within the seat, and further comprising:
detecting a position and an orientation of the seat in the vehicle; and
generating the control signal further as a function of the position and the orientation of the seat in the vehicle and the weight distribution within the seat.

20. The method of claim 19, further comprising:
detecting an object in a travel path of the vehicle; and
generating the control signal further as a function of the detected object in the travel path of the vehicle.
